(19) United States
(12) Patent Application Publication
(10) Pub. No.: US 2026/0156578 A1
(43) Pub. Date: Jun. 4, 2026

(54) UNIFIED POWER CONTROL FRAMEWORK FOR UPLINK TRANSMISSIONS

(71) Applicant: QUALCOMM Incorporated, San Diego, CA (US)

(72) Inventors: Yi Huang, San Diego, CA (US); Linhai He, San Diego, CA (US); Jing Sun, San Diego, CA (US); Xiao Feng Wang, San Diego, CA (US); Jing Jiang, San Diego, CA (US)

(21) Appl. No.: 18/968,889

(22) Filed: Dec. 4, 2024

(51) Int. Cl. H04W 52/08; H04W 52/14

(52) U.S. Cl. CPC H04W 52/08; H04W 52/146

(57) ABSTRACT

A unified power control framework for uplink transmissions enables multiple uplink transmission types to share closed-loop power control loops (CLPCLs), each associated with a unique index. Each transmission type is mapped to a respective CLPCL index, with multiple types potentially sharing the same index. Power control commands include particular CLPCL indexes to coordinate power adjustments across channels or signals mapped to the same loop. Different step sizes may be applied when adjusting transmit power for different transmission types sharing an index. Power control command accumulation identifies a first border while leaving a second border undefined, simplifying timing relationships. When calculated adjusted transmit powers exceed limits, the framework sets transmit powers to respective maximum or minimum values. Power control states associated with indexes can be reset to initial values, and mappings can be dynamically modified to change transmission types between different indexes.

### TECHNICAL FIELD

This disclosure relates generally to wireless communication, and more specifically, to unified power control frameworks for uplink transmissions that enable multiple uplink channels or signals to share closed-loop power control loops.

### INTRODUCTION

Uplink power control is important for managing interference and ensuring reliable communications between user equipment (UE) and base stations in wireless communication systems. Power control mechanisms typically include both open-loop and closed-loop components to adapt transmit power based on channel conditions and system requirements.

In known wireless systems, each uplink channel or signal type has its own dedicated closed-loop power control mechanism. For example, Physical Uplink Shared Channel (PUSCH) communications utilize open-loop power control plus two closed-loop power control options, where the network configures which closed-loop to use. Similarly, Physical Uplink Control Channel (PUCCH) communications employ open-loop power control plus two closed-loop power control options. Sounding Reference Signal (SRS) transmissions also use open-loop power control plus two closed-loop power control options, where one closed-loop follows the PUSCH closed-loop and the other is standalone for SRS.

The approach of maintaining separate closed-loops for different uplink transmission types presents several challenges. First, a UE must track several, e.g., up to five or six independent loops, which increases implementation complexity. Second, when traffic is asymmetrical between uplink and downlink power control accuracy may suffer due to sparse transmission of power control commands. For example, during periods of sparse downlink traffic the network rarely sends downlink control information (DCI) to schedule Physical Downlink Shared Channel (PDSCH) transmissions. This can prevent PUCCH power control closed-loops from accurately tracking channel variations. Also, when a burst of downlink traffic arrives, the PUCCH power for acknowledgment/negative-acknowledgment transmissions may be inaccurate, potentially causing reception failures at the base station due to insufficient transmit power. Similar issues can occur during periods of sparse uplink traffic.

Additionally, SRS power control closed-loops can only be driven by dedicated DCI formats unless they are configured to follow PUSCH closed-loops. As such, SRS power control may be inaccurate unless the network frequently sends the appropriate DCI formats with power control commands.

The limitations of separate closed-loop power control mechanisms underscore inefficiencies in current systems. Beyond implementation complexity and traffic-dependent accuracy issues, separate loops create challenges for network optimization and scalability. As wireless systems evolve to support more diverse transmission types and service requirements, the overhead of maintaining individual power control mechanisms for each new channel or signal type becomes increasingly burdensome. As such, there is a need for unified power control frameworks that can coordinate power adjustments across multiple transmission types while reducing implementation complexity and maintaining accuracy across channel conditions and traffic patterns.

### BRIEF SUMMARY OF SOME EXAMPLES

The systems, methods and devices of this disclosure each have several innovative aspects, no single one of which is solely responsible for the desirable attributes disclosed herein.

One innovative aspect of the subject matter described in this disclosure can be implemented in a wireless communication device. The wireless communication device configures multiple closed-loop power control loops (CLPCLs) for uplink transmissions, where each CLPCL is associated with an index in a plurality of indexes, with each index being unique to other indexes in the plurality. The device maps each of multiple uplink transmission types to a respective CLPCL index from the plurality of indexes, allowing multiple transmission types to share the same respective index. Upon receiving a power control command that includes a particular CLPCL index from the plurality of indexes, the device adjusts transmit power for all uplink transmission types mapped to that particular index.

In some examples, the power control command is received in downlink control information (DCI) that schedules an uplink or downlink transmission and includes an indicator of the particular CLPCL index. In other examples, the device identifies a first border of an accumulation region for the power control command while leaving a second border of the accumulation region undefined, and determines which power control commands to apply based on the identified accumulation region. In additional examples, the uplink transmission types include at least two of: Physical Uplink Control Channel (PUCCH), Physical Uplink Shared Channel (PUSCH), Sounding Reference Signal (SRS), or Physical Random Access Channel (PRACH).

In further examples, different step sizes are applied when adjusting transmit power for different uplink transmission types mapped to the particular CLPCL index based on the power control command. The device calculates an adjusted transmit power based on applying the power control command and, when the calculated adjusted transmit power exceeds a maximum transmit power or falls below a minimum transmit power for a first uplink transmission type, sets the transmit power for that transmission type to the respective maximum or minimum transmit power limit. In further examples, a power control state associated with a first CLPCL index is reset to an initial value when an associated open-loop power control parameter is reconfigured, and explicit signals can reset power control states associated with CLPCL indexes, optionally to non-zero power values. Additionally, the device can dynamically modify the mapping to change uplink transmission types between different CLPCL indexes. In yet other examples, the DCI includes a dedicated CLPCL indicator for various DCI formats including DCI format 0_0, DCI format 0_1, DCI format 0_2, DCI format 1_0, DCI format 1_1, DCI format 1_2, or DCI format 2_2. In related examples, for certain DCI formats including 0_0, 0_1, or 0_2, the device reuses sounding reference signal indicators for PUSCH to indicate the particular CLPCL index.

Another innovative aspect of the subject matter described in this disclosure can be implemented in a method for wireless communication. The method includes configuring multiple CLPCLs for uplink transmissions where each CLPCL is associated with an index in a plurality of unique indexes, mapping uplink transmission types to respective CLPCL indexes where multiple types may share the same respective index, receiving power control commands including particular CLPCL indexes, and adjusting transmit power for transmission types mapped to the indicated particular indexes.

In other examples, the method includes receiving power control commands via DCI, identifying first borders of accumulation regions while leaving second borders undefined, accommodating different transmission types through varied step sizes, and implementing power saturation mechanisms based on calculated adjusted transmit powers. The method further provides for resetting power control states associated with indexes to initial values, including non-zero values, and enables dynamic modification of mappings to change transmission types between indexes. Additionally, the method supports various DCI format configurations for indicating CLPCL indexes, including reuse of existing sounding reference signal indicators.

Another innovative aspect of the subject matter described in this disclosure can be implemented in a base station device for wireless communication. The device configures multiple CLPCLs for uplink transmission from one or more user equipments (UEs), where each CLPCL is associated with an index in a plurality of indexes, with each index being unique to other indexes in the plurality. The device assigns mappings between uplink transmission types and respective CLPCL indexes, allowing multiple transmission types to share the same respective index, transmits these mapping assignments to UEs, and sends power control commands including particular CLPCL indexes to adjust transmit power for mapped uplink transmission types.

In some examples, the device transmits power control commands via DCI scheduling transmissions, with the DCI including indicators of particular CLPCL indexes. In additional examples, the device may configure a single closed-loop power control loop having a single index and map all uplink transmission types to this index. In other examples, the device can transmit signaling to cause UEs to modify their mappings to change transmission types between different CLPCL indexes, particularly before transmitting commands to reset power control states associated with specific indexes.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale. Further, aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network 100, in accordance with aspects of the present disclosure.

FIG. 2 is a diagram illustrating an example network node 110 in communication with an example UE 120 in a wireless network, in accordance with aspects of the present disclosure.

FIG. 3 is a diagram illustrating an example disaggregated base station architecture 300, in accordance with aspects of the present disclosure.

FIG. 4 is a diagram illustrating an example of physical channels and reference signals in a wireless network, in accordance with aspects of the present disclosure.

FIG. 5 is a diagram illustrating an example of link adaptation 500, in accordance with aspects of the present disclosure.

FIG. 6 is a diagram illustrating a method 600 for wireless communication, in accordance with aspects of the present disclosure.

FIG. 7 shows a diagram of an example apparatus 700 for wireless communication, in accordance with aspects of the present disclosure.

FIG. 8 illustrates a method 800 for wireless communication at a network node, in accordance with aspects of the present disclosure.

FIG. 9 shows a diagram of an example device 900 for wireless communication, in accordance with aspects of the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, wireless communication systems enable user equipment (UE) and base stations to exchange power control information for uplink transmissions. Through a unified framework, these network nodes communicate using shared power control loops that coordinate power adjustments across multiple transmission types. This approach represents an evolution from traditional systems where power control mechanisms operate independently for each transmission type.

Network nodes participate in this framework through complementary roles. Base stations configure and manage the closed-loop power control structure, determining how many control loops to establish and how different uplink transmission types map to these loops. They communicate these configurations to UEs through control signaling and issue power control commands referencing specific loop indexes. UEs, in turn, implement these configurations by mapping their various uplink transmission types to the indicated indexes and adjusting transmit power according to received commands.

The interaction between network nodes enables dynamic power control management. Base stations can modify mappings between transmission types and control loops, trigger loop resets, and coordinate power adjustments across multiple UEs sharing the same resources. UEs respond to these network commands while maintaining consistent power control behavior across their various transmission types, even when multiple types share the same control loop index.

Wireless communication systems employ power control mechanisms to manage uplink transmissions between user equipment (UE) and base stations. The present disclosure discloses implementations of a unified framework for closed-loop power control that allow multiple uplink transmission types to share common power control loops. Such implementations represent a departure from conventional systems where each uplink channel or signal type maintains separate power control mechanisms, i.e., requiring dedicated loops and distinct control processes for each transmission type.

In a unified framework according to implementations described herein, a configurable number of closed-loop power control loops (CLPCLs) are established with each loop assigned a unique index. Different uplink transmission types-such as Physical Uplink Control Channel (PUCCH), Physical Uplink Shared Channel (PUSCH), Sounding Reference Signal (SRS), and Physical Random Access Channel (PRACH) can be mapped to the indexes. Multiple transmission types may share the same CLPCL index, thereby creating a flexible power control structure that adapts to varying system requirements. This mapping approach improves how power control relationships are managed, i.e., moving from rigid one-to-one associations between transmission types and control loops to a dynamic, many-to-one framework that can evolve with system needs.

Power control commands can reference specific CLPCL indexes to trigger adjustments across all mapped transmission types. Implementations utilize power management techniques, including differential step sizes for transmission types sharing an index, reset mechanisms for handling parameter reconfigurations, and dynamic transmission type switching between indexes. The foregoing capabilities enable granular power control while maintaining a simplified loop structure. When commands are received, they are processed according to accumulation regions defined by single border points, streamlining timing relationships compared to traditional dual-border approaches. Such a unified frame work can implement consistent power saturation behavior by, e.g., applying commands before enforcing individual transmission type power limits—to ensure predictable operation even when shared loops include transmission types with different power constraints.

Further, integration with existing network infrastructure can be achieved through downlink control information (DCI) formats that support both dedicated indicators and reuse of existing signaling mechanisms. Some implementations can account for varying quality of service requirements through multiple mechanisms, including configurable step sizes, power offsets, and the ability to group transmission types with similar requirements under shared indexes. Initial power control relationships are established during random access procedures, with subsequent loops inheriting proven power levels, to ensure stable operation from system initialization through dynamic reconfiguration scenarios.

Implementations of a framework can also provide targeted solutions for specific operational challenges, such as asymmetric traffic patterns where certain transmission types traditionally suffer from sparse power control updates. By sharing power control loops, transmission types can maintain accurate power levels even during periods of infrequent direct commands, leveraging updates intended for other transmissions sharing their index. As such, described implementations account for both systemic power control challenges and specific operational scenarios while maintaining implementation efficiency.

Particular implementations of the subject matter described in this disclosure may be implemented to realize one or more of the following potential advantages or benefits. In some aspects, the present disclosure provides techniques for simplifying power control implementation in wireless devices while improving power control accuracy across different channel conditions and traffic scenarios.

By enabling multiple uplink transmission types to share closed-loop power control loops, implementations reduce the number of independent loops that a user equipment must track and manage. This consolidation substantially decreases implementation complexity compared to conventional approaches requiring several loops. Moreover, a unified approach accommodates future expansion because additional uplink transmission types can be readily integrated into an existing framework by mapping them to appropriate indexes, which eliminates the need to implement and maintain new dedicated control loops for each new transmission type.

According to some implementations described herein, a unified framework's ability to apply power control commands across multiple transmission types sharing an index enables more frequent power adjustments for all mapped channels. When traffic is asymmetric between uplink and downlink, transmission types that would traditionally receive sparse power control commands can benefit from commands targeting other transmission types mapped to the same index. Such coordination is particularly valuable in scenarios like sparse downlink traffic, where PUCCH power control traditionally suffers from infrequent updates. Under a unified framework, PUCCH can maintain accurate power control by leveraging commands intended for other transmission types sharing its index. This helps prevent issues like ACK/NACK reception failures that can occur when power control does not adequately track channel variations, particularly during burst traffic scenarios where accurate power control becomes especially important for system performance.

Support for different step sizes allows transmission types sharing an index to maintain appropriate power levels for their specific requirements to effectively create virtual control loops within a unified structure. This capability extends beyond simple power differentiation and enables power control strategies where transmission types with stringent Block Error Rate (BLER) requirements can implement larger step sizes for faster adaptation. This can be accomplished while maintaining stable power control for services with less demanding requirements. Simplified accumulation regions, defined by single border points, streamline timing relationships while maintaining proper power control behavior. Additionally, the framework accommodates different quality of service (QoS) requirements through complementary mechanisms like configurable power offsets to provide tools for managing diverse transmission requirements within the shared loop structure. The foregoing approach to power control enables granular management of different service types, such as Ultra-Reliable Low-Latency Communication (URLLC) and enhanced Mobile Broadband (eMBB), within the same unified framework.

Dynamic index management capabilities, including reset mechanisms and transmission type switching, provide flexibility in handling parameter reconfigurations without disrupting power control for unaffected transmission types. According to some implementations, the framework's approach to power saturation, where commands are always applied before limiting final power levels, ensures consistent behavior across transmission types while accounting for their individual operating constraints. Integration with existing DCI formats and indicator reuse minimizes additional signaling overhead while supporting the enhanced power control functionality, which illustrates how sophisticated power control improvements can be achieved without significant increases in system complexity or signaling requirements. The framework supports various DCI format configurations for indicating CLPCL indexes, including dedicated indicators in formats 0_0 through 2_2, and enables efficient reuse of existing indicators such as sounding reference signal indicators for PUSCH. Th foregoing approach to DCI format utilization allows implementations to optimize signaling overhead based on specific deployment scenarios while maintaining power control functionality.

In view of the foregoing, it should be appreciated that the present disclosure includes a unified closed-loop power control framework for uplink transmissions that changes how power control is managed in wireless communication systems. That is, unlike conventional systems where each channel or signal type maintains independent power control loops, implementations of the framework enable sharing of closed-loop power control mechanisms across different uplink transmission types.

In conventional systems, uplink power control employs separate equations for different transmission types. For PUSCH transmissions, the power control follows:

$${P}_{PUSCH , b , f , c} ( i , j , {q}_{d} , l ) = min \{ \begin{matrix}{P}_{CMAX , f , c} ( i ) , \\ \begin{matrix}{P}_{{O}_{\_ PUSCH} , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {u}_{b , f , c} ( i )\end{matrix}\end{matrix} \} [ dBm ]$$

where: P_CMAX,k,c(i) represents the maximum allowable transmit power, P_0,PUSCH,k,c(j) is the base power level for PUSCH, M_PUSCH,k,c(i) represents the number of resource blocks, α_k,f,c(j) is the path loss compensation factor, PL_k,f,c(q_k) represents the downlink path loss estimate, Δ_TF,k,c(i) accounts for transport format adjustments, and f_k,c(i, l) represents the closed-loop power control component with index 1.

For PUCCH transmissions, the power control equation is:

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{{O}_{\_ PUCCH} , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{{F}_{\_ PUCCH}} ( F ) + {Δ}_{TF , b , f , c} ( i ) + {u}_{b , f , c} ( i )\end{matrix}\end{matrix} \} [ dBm ]$$

where the additional terms include: P_0,PUCCH,k,c(q_k) as the base power level for PUCCH, Δ_F_PUCCH(F) representing PUCCH format-specific power adjustments, and g_k,c(i, l) as the PUCCH-specific closed-loop power control component.

For SRS transmissions, the power control follows:

$${P}_{SRS , b , f , c} ( i , {q}_{s} , l ) = min \{ \begin{matrix}{P}_{CMAX , b , f , c} ( i ) , \\ \begin{matrix}{P}_{{O}_{\_ SRS} , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {u}_{b , f , c} ( i )\end{matrix}\end{matrix} \} [ dBm ]$$

where: P_0,SRS,k,c(q_k) is the base power level for SRS, α_SRS,k,c(q_k) represents the SRS-specific path loss compensation factor, and h_k,c(i, l) is the SRS-specific closed-loop power control component.

Implementations of a unified framework disclosed herein modify the foregoing equations to enable shared closed-loop power control while preserving transmission-specific parameters. The modifications primarily affect the closed-loop components f_k,c(i, l), g_k,c(i, l), and h_k,c(i, l), which traditionally operate independently. According to an implementation, the foregoing components can reference the same closed-loop power control index 1—allowing multiple transmission types to respond to the same power control commands.

Implementations maintain transmission-specific open-loop components, including the P_0 values and path loss compensation factors, which account for differences in transmission requirements. For instance, PUCCH/PUSCH/SRS/PRACH transmissions require different transmit powers due to varying decoding SNR requirements at the receiver. These differences are accommodated through different P_0 values and transmission-specific interpretation of the unified closed-loop commands.

Command interpretation can vary according to transmission requirements through different step sizes. For example, when PUCCH and PUSCH transmissions share closed-loop index 0, a single TPC command applies to both channels but may be interpreted with different step sizes. Transmissions with stringent Block Error Rate (BLER) requirements may employ larger step sizes for faster power adaptation to create virtual closed-loops within the unified framework.

Known systems define accumulation regions using both left and right borders for each transmission type where TPCs within the borders accumulate for specific transmission types. However, implementations described herein simplify this requirement by maintaining only the right border reference point with the left border conceptually extending to negative infinity. For uplink transmissions scheduled through Downlink Control Information (DCI), the right border corresponds to the last symbol of the associated DCI. And for transmissions without explicit DCI scheduling, such as configured grant PUSCH, the right border is calculated as the first symbol of the uplink transmission minus K2 multiplied by the number of symbols per slot.

It should also be appreciated that implementations described herein utilize power saturation control that differs from that of conventional systems. In known systems, when the total power (sum of open-loop and closed-loop components) exceeds P_CMAX or falls below P_CMIN, the system ignores TPC commands entirely. However, such an approach becomes problematic in a unified framework where multiple transmission types share closed-loop control. But according to described implementations, different uplink transmissions sharing a closed-loop may have different open-loop power settings through their individual P_0 values. Consequently, power saturation occurring for one transmission type does not necessarily indicate saturation for other transmissions sharing the same closed-loop index. Implementations can address this by always applying TPC commands at the closed-loop level and then individually saturating the total transmit power at P_CMAX or P_CMIN for each transmission type, as needed. For instance, if P_openloop+P_closedloop exceeds P_CMAX for a PUSCH transmission but remains within bounds for a PUCCH transmission sharing the same index, the framework applies the power control command to both transmissions, then saturates only the PUSCH power at P_CMAX.

Described implementations can also provide mechanisms for closed-loop power control management across multiple transmission types. During initial access procedures, the default closed-loop index automatically links with Random Access Channel (RACH) transmission types. The framework specifies explicit initialization procedures when the network configures additional loops (where X represents the number of loops and may exceed 1) following successful RACH completion. In such cases, newly configured loops initialize their power levels to match the power level established by the default loop during initial access, ensuring consistent power control across all configured loops.

With respect to DCI format, implementations described herein can implement power control command delivery through modified DCI formats, which provides flexibility in how commands target specific closed-loop indexes. In conventional systems, PUSCH power control commands are delivered through DCI formats 1_0, 1_1, 1_2, and 2_2 with CRC scrambled by TPC-PUSCH-RNTI, while PUCCH commands utilize DCI formats 0_0, 0_1, 0_2, and 2_2 with CRC scrambled by TPC-PUCCH-RNTI. SRS power control traditionally relies on dedicated DCI format 2_3.

There are at least two implementations for delivering power control commands through DCI. The first implementation adds a dedicated closed-loop power control loop indicator to DCI formats 0_0, 0_1, 0_2, 1_0, 1_1, 1_2, and 2_2. This approach enables removal of the dedicated DCI format 2_3 for SRS power control, streamlining the control signaling structure. The second implementation adds the dedicated indicator only to DCI formats 1_0, 1_1, 1_2, and 2_2, while reusing existing sounding reference signal indicators for PUSCH to convey CLPCL index information in formats 0_0, 0_1, and 0_2.

Implementations can also support dynamic management of transmission type mappings to closed-loop indexes through network signaling. When the network needs to reset a particular closed-loop index while preserving power control for some transmissions using that index it can execute a coordinated switching procedure. For example, before resetting closed-loop index 1 for an SRS transmission (designated as transmission A), the network may switch a PUSCH transmission (designated as transmission B) from index 1 to index 0. Such a switching capability enables precise control over power control relationships while maintaining continuous operation.

Radio Resource Control (RRC) signaling can indicate the mappings between uplink transmission types and closed-loop indexes. These mappings accommodate varying operational requirements, such as the differentiation between PUCCH formats supporting multi-user (MU) operations and those that do not. For instance, PUCCH formats 0, 1, and 4, which support MU operations within the same resource block, may share index 0 to enable more precise interference management. Meanwhile, PUCCH formats 2 and 3, which do not support MU operations, may share index 1 with PUSCH transmissions.

With respect to Quality of Service and Block Error Rate (BLER) target management, there are at least three implementations for managing different Block Error Rate BLER targets across transmission types sharing closed-loop indexes. The first approach introduces additional power offsets in the power control equations. These offsets, which can be semi-statically configured through RRC signaling or dynamically updated via MAC-CE or DCI, account for transmit power differences between uplink transmissions sharing the same closed-loop power control index. The second approach leverages differential step size interpretation of Transmit Power Control (TPC) commands within a shared closed-loop index. For transmissions with stringent BLER requirements, such as Ultra-Reliable Low-Latency Communication (URLLC), the framework applies larger step sizes to enable faster power adaptation. Conversely, transmissions with more relaxed BLER targets, such as enhanced Mobile Broadband (eMBB), utilize smaller step sizes while responding to the same TPC commands. For example, when a PUCCH channel and PUSCH channel share closed-loop index 0, a single TPC command might translate to a 3 dB adjustment for PUCCH and a 1 dB adjustment for PUSCH, effectively creating virtual closed-loops within the unified control structure. The third approach groups uplink transmissions according to their BLER requirements by assigning them to different closed-loop indices. This network-implementation approach requires no additional signaling or processing mechanisms as it utilizes the basic mapping capabilities of the framework to achieve BLER target differentiation. Network implementations may combine these approaches based on specific deployment scenarios and operational requirements.

Beyond the previously described RACH-based initialization, implementations can transition from single-loop to multi-loop operation (X>1), newly configured loops inherit the power state of the default loop used during RACH, ensuring consistent power control across all transmission types. This prevents power discontinuities that could otherwise occur during loop reconfiguration.

Further, state management can extend to scenarios involving temporary deactivation or suspension of transmission types. When a transmission type becomes inactive, its power control state is preserved within its assigned closed-loop index, enabling seamless resumption of proper power levels when the transmission type reactivates. This operates independently for each transmission type sharing a closed-loop index, maintaining proper power relationships across all active transmissions.

Implementations of the framework described herein can process multiple power control commands according to specific timing relationships. When two commands (e.g., TPC1 and TPC2) target transmissions sharing the same closed-loop index, implementations can apply their combined effect to all mapped transmission types. For example, when both PUCCH and PUSCH share closed-loop index 0, implementations can apply the sum of TPC1 and TPC2 to both transmission types, subject to their respective step size interpretations.

The timing relationships can follow specific patterns illustrated by two scenarios. In the first scenario, implementations can process DCI format 1_1 scheduling PUSCH transmissions with timing offset K(i) relative to the DCI, while maintaining a timing offset K(i−1) for previous transmissions. A one-symbol gap can separate consecutive transmissions, enabling proper command accumulation.

Implementations can handle configured grant PUSCH transmissions differently, where the timing relationship uses K(i) equal to K2 multiplied by the number of symbols in a slot. This arrangement can accommodate transmissions that lack explicit DCI scheduling while maintaining proper power control timing relationships.

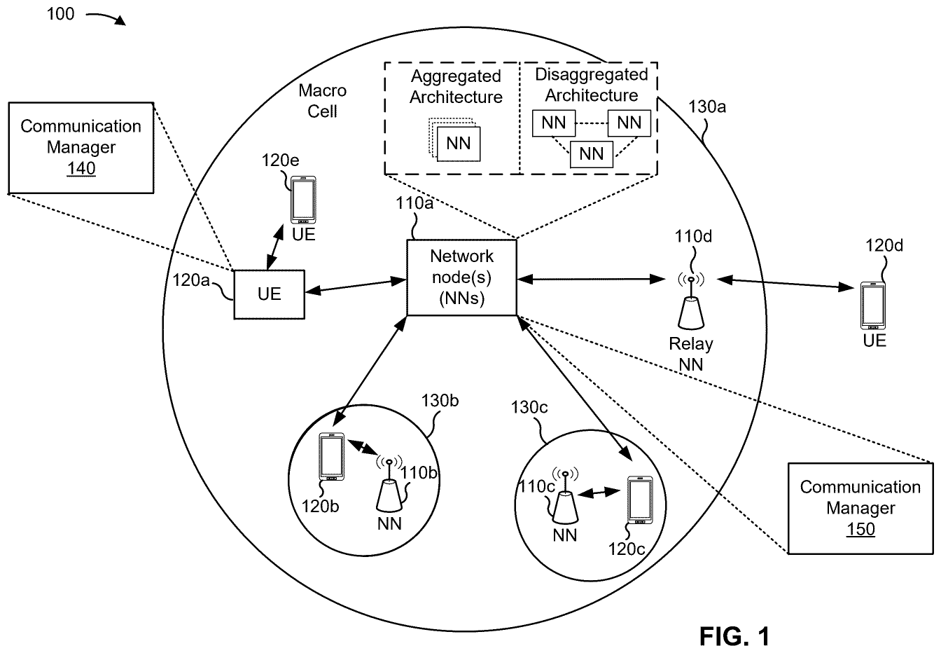

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more PUCCHs, and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may obtain an indication that a model, associated with at least one of encoding or decoding, is to be used in association with a control channel; output, after obtaining the indication, one or more model parameters associated with a data distribution of the control channel; encode data by using the one or more model parameters; and output the data for transmission via the control channel. Additionally, or alternatively, the communication manager 140 may perform one or more other operations described herein.

In some aspects, the network node 110 may include a communication manager 150. As described in more detail elsewhere herein, the communication manager 150 may output an indication that a model, associated with at least one of encoding or decoding, is to be used in association with a control channel; obtain, after outputting the indication that the model is to be used, one or more model parameters associated with a data distribution of the control channel; obtain data associated with the control channel; and decode the data by using the one or more model parameters. Additionally, or alternatively, the communication manager 150 may perform one or more other operations described herein.

As indicated above, FIG. 1 is provided as an example. Other examples may differ from what is described with regard to FIG. 1.

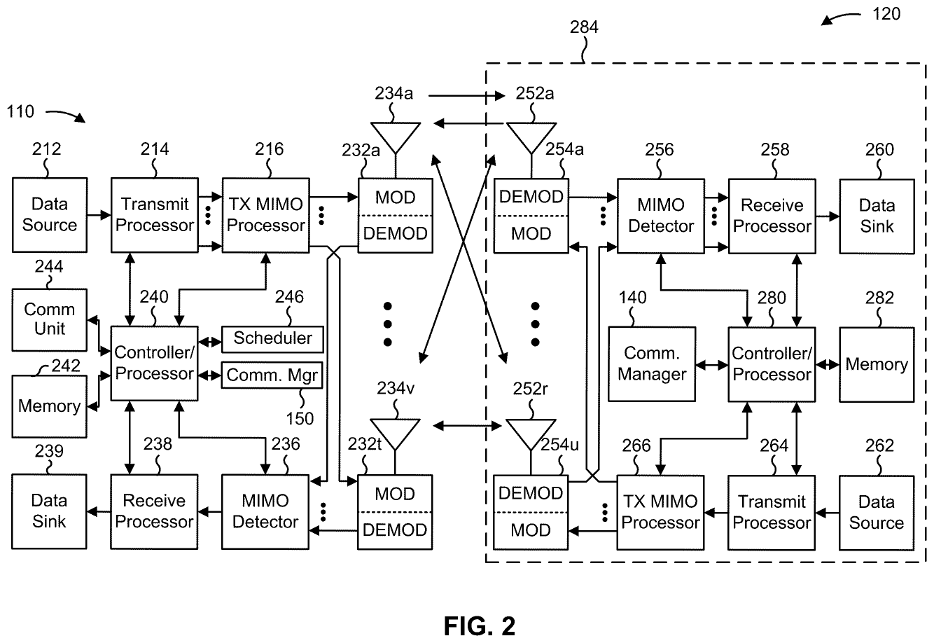

FIG. 2 is a diagram illustrating an example network node 110 in communication with an example UE 120 in a wireless network, in accordance with the present disclosure. As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding scheme (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC-CE communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

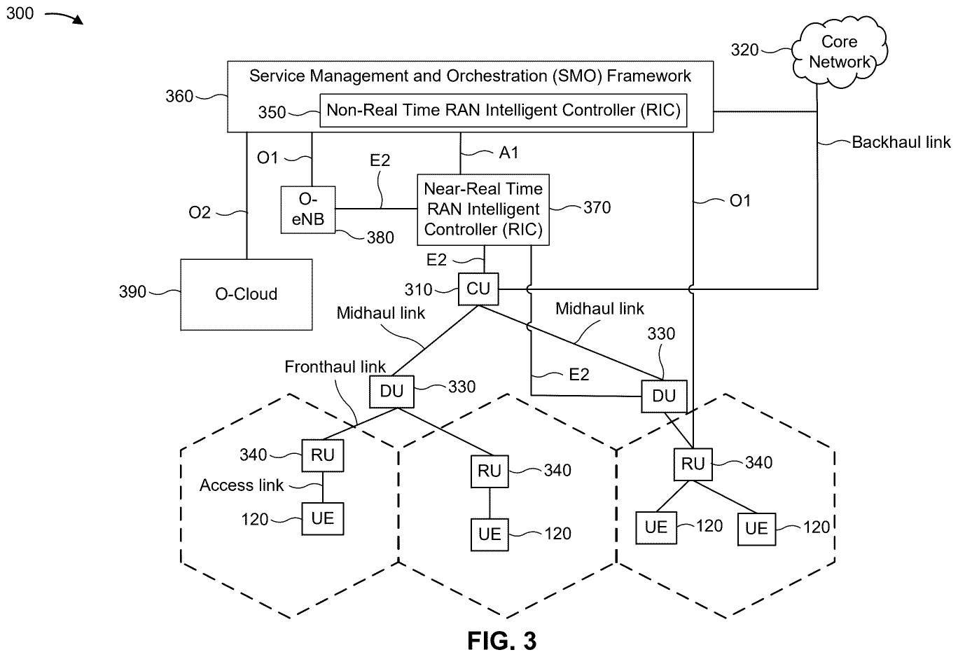

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

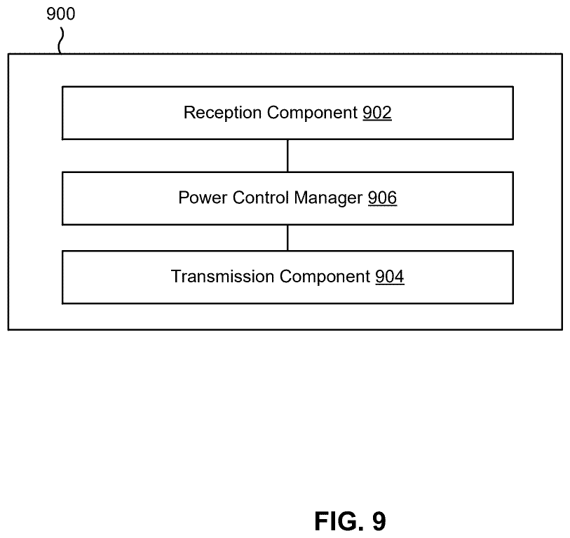

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with model management for control channel encoding or decoding, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). In some aspects, the wireless node described herein is the network node 110, is included in the network node 110, and/or includes one or more components of the network node 110 shown in FIG. 2. Additionally, or alternatively, the wireless node described herein is the UE 120, is included in the UE 120, and/or includes one or more components of the UE 120 shown in FIG. 2. For example, as used herein, “wireless node” refers to the network node 110 or the UE 120.

The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for obtaining an indication that a model, associated with at least one of encoding or decoding, is to be used in association with a control channel; means for outputting, after obtaining the indication, one or more model parameters associated with a data distribution of the control channel; means for encoding data by using the one or more model parameters; and/or means for outputting the data for transmission via the control channel. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some examples, means for transmitting or sending may include a transceiver and/or one or more antennas of UE 120 described in connection with FIG. 2. In some examples, means for receiving may include a transceiver and/or one or more antennas the UE 120 described in connection with FIG. 2.

Means for obtaining, means for determining, means for performing, means for estimating, means for training, means for processing, means for encoding, means for identifying, means for selecting, means for training, means for resetting, means for detecting, and/or means for outputting may include one or more processors or components of the UE 120 described above in connection with FIG. 2, such as one or more of communication manager 140, modem 254, MIMO detector 256, receive processor 258, transmit processor 264, TX MIMO processor 266, controller/processor 280, memory 282, or a combination thereof.

In some aspects, the network node 110 includes means for outputting an indication that a model, associated with at least one of encoding or decoding, is to be used in association with a control channel; means for obtaining, after outputting the indication that the model is to be used, one or more model parameters associated with a data distribution of the control channel; means for obtaining data associated with the control channel; and/or means for decoding the data by using the one or more model parameters. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

In some examples, means for transmitting or sending may include a transceiver and/or one or more antennas of the network node 110 described in connection with FIG. 2. In some examples, means for receiving may include a transceiver and/or one or more antennas of the network node 110 described in connection with FIG. 2.

Means for obtaining, means for performing, means for estimating, means for decoding, means for training, means for processing, means for identifying, means for selecting, means for training, means for resetting, means for detecting, and/or means for outputting may include one or more processors or components of the network node 110 described above in connection with FIG. 2, such as such as one or more of communication manager 150, one or more antennas 234, modem 232, TX MIMO processor 216, transmit processor 214, or a combination thereof.

As indicated above, FIG. 3 is provided as an example. Other examples may differ from what is described with regard to FIG. 3.

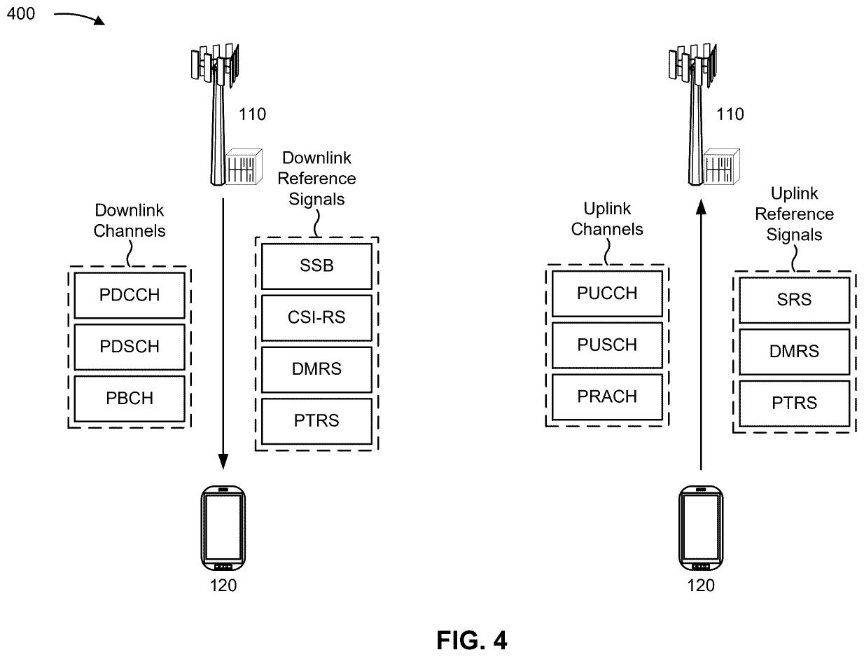

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, a PDSCH that carries downlink data, or a physical broadcast channel (PBCH) that carries system information, among other examples. In some aspects, PDSCH communications may be scheduled by PDCCH communications. As further shown, an uplink channel may include a PUCCH that carries UCI, a PUSCH that carries uplink data, or a PRACH used for initial network access, among other examples. In some aspects, the UE 120 may transmit ACK or NACK feedback (e.g., ACK/NACK feedback or ACK/NACK information) in UCI on the PUCCH and/or the PUSCH. The feedback may be HARQ feedback for data transmitted via the PDSCH or another downlink channel.

As further shown, a downlink reference signal may include a synchronization signal block (SSB), a CSI-RS, a DMRS, a positioning reference signal (PRS), or a phase tracking reference signal (PTRS), among other examples. As also shown, an uplink reference signal may include an SRS, a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a precoding matrix indicator (PMI), a CSI-RS resource indicator (CRI), a layer indicator (LI), a rank indicator (RI), or an RSRP, among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random quadrature phase shift keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

The UE 120 and the network node 110 may support retransmissions of data to increase the likelihood that data is received successfully. HARQ feedback is one technique for increasing the likelihood that data is received correctly via a communication link or channel. HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise ratio conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The UE 120 may receive downlink signaling from the network node 110. The UE 120 may transmit feedback messages for the downlink signaling. For example, the UE 120 may transmit a feedback codebook (e.g., a sequence of bits that indicate feedback for one or multiple downlink transmissions), such as a HARQ ACK or NACK codebook including feedback bits indicating ACK or NACK information for the received downlink signaling. The UE 120 may transmit the feedback (e.g., the feedback codebook) via an uplink channel, such as the PUCCH. In some examples, the UE 120 may be more likely to transmit an ACK indication (e.g., bit 0) than a NACK indication (e.g., bit 1). For example, at a 10% BLER in the PDSCH, the UE 120 may transmit 90% ACK indications and 10% NACK indications. However, current codebooks are designed for uniform probability of messages with equal likelihood of the bit 0 and bit 1, and power is applied uniformly to the non-uniform messages. This results in inefficient power utilization.

Therefore, in some examples, the UE 120 and/or the network node 110 may use a power shaping scheme for encoding and decoding control channel communications, such as data transmitted via the PUCCH. As described in more detail elsewhere herein, the power shaping scheme may be associated with the UE 120 determining a transmit power for codewords included in a codebook using a set of power shaping parameters. The set of power shaping parameters may be associated with respective codewords of the codewords included in a codebook. In other words, each codeword may have a dedicated power shaping parameter that has a value that is based on, or otherwise associated with, a probability of occurrence of that codeword, as described in more detail elsewhere herein.

As indicated above, FIG. 4 is provided as an example. Other examples may differ from what is described with regard to FIG. 4.

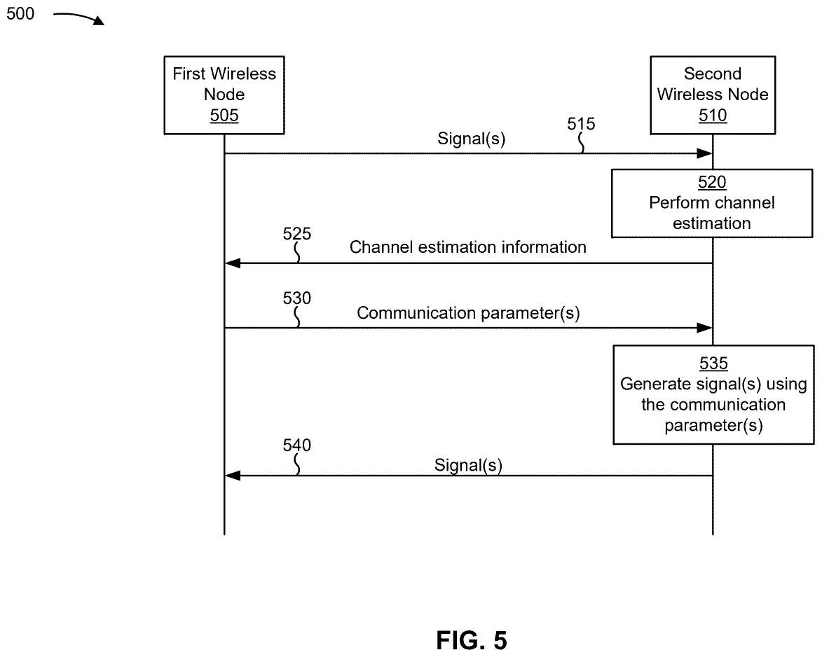

FIG. 5 is a diagram illustrating an example 500 of link adaptation, in accordance with the present disclosure. As shown in FIG. 5, a first wireless node 505 (e.g., a UE 120 or a network node 110) may communicate with a second wireless node 510 (e.g., a UE 120 or a network node 110). In some examples, the first wireless node 505 may be a network node 110, and the second wireless node 510 may be a UE 120. In other examples, the first wireless node 505 and the second wireless node 510 may be other types of wireless communication devices (e.g., both the first wireless node 505 and the second wireless node 510 may be UEs). The first wireless node 505 and the second wireless node 510 may communicate via a wireless communication network, such as the wireless communication network 100.

The first wireless node 505 and the second wireless node 510 may perform link adaptation to dynamically adjust communication parameters (e.g., transmission parameters) based on, in response to, or otherwise associated with, an estimated quality of a communication link, such as one or more communication channels (e.g., the PDSCH, the PUSCH, the PDCCH, and/or the PUCCH). For example, in a wireless communication network, channel conditions between the first wireless node 505 and the second wireless node 510 may vary due to one or more factors, such as a distance between the first wireless node 505 and the second wireless node 510, one or more obstacles in the environment (e.g., that may block or deflect transmitted beams or signals), and/or interference from other signals, among other examples. One example of link adaptation is outer-loop link adaptation (OLLA). Unlike inner-loop link adaptation, which adapts one or more parameters based on short-term variations in a channel, OLLA enables parameter adaptation based on longer-term variations, making OLLA more suitable for optimizing system performance over time.

For example, as shown by reference number 515, the first wireless node 505 may transmit, and the second wireless node 510 may receive, one or more signals. The one or more signals may include one or more reference signals, data signals, control signals, and/or other types of signals. The one or more signals may be transmitted via a communication channel, such as the PDSCH, the PDCCH, the PUSCH, and/or the PUCCH. As shown by reference number 520, the second wireless node 510 may perform channel estimation based on, or using, the one or more signals. For example, the second wireless node 510 may decode, measure, and/or otherwise process the one or more signals to estimate one or more channel estimation parameters. In some examples, the second wireless node 510 may determine CSI based on measuring and/or otherwise processing the one or more signals. The one or more channel estimation parameters may include one or more CSI parameters, a CQI parameter, an RSRP parameter, an RSSI parameter, an RSRQ parameter, a TPC parameter, and/or another parameter.

As shown by reference number 525, the second wireless node 510 may transmit, and the first wireless node 505 may receive, channel estimation information (e.g., for the channel via which the one or more signals were transmitted as described in connection with reference number 515). The channel estimation information may include the one or more channel estimation parameters and/or CSI for the channel. For example, the channel estimation information may be included in a CSI report.

The first wireless node 505 may determine, adjust, and/or set one or more communication parameters to be used by the second wireless node 510 based on the channel estimation information. For example, the first wireless node 505 may determine an appropriate MCS to be used by the second wireless node 510 based on the channel estimation information. As another example, the first wireless node 505 may determine a transmit power, one or more power control parameters, and/or a frame structure, among other examples, based on the channel estimation information. In some examples, the first wireless node 505 may determine, adjust, and/or set one or more communication parameters to maintain or achieve a target error rate for data (e.g., a payload) transmitted via the channel (e.g., a target BLER). For example, the first wireless node 505 may determine, adjust, and/or set one or more communication parameters based on the channel estimation information and/or based on feedback from the second wireless node 510 (e.g., HARQ feedback) to maintain or achieve the target error rate.

As shown by reference number 530, the first wireless node 505 may transmit, and the second wireless node 510 may receive, the one or more communication parameters, such as an MCS, a transmit power, one or more power control parameters, among other examples. For example, the first wireless node 505 may configure the second wireless node 510 to use the one or more communication parameters. As shown by reference number 535, the second wireless node 510 may generate one or more signals using the one or more communication parameters. As shown by reference number 540, the second wireless node 510 may transmit, and the first wireless node 505 may receive, the one or more signals (e.g., that were generated using the one or more communication parameters).

In some examples, the second wireless node 510 may transmit, and the first wireless node 505 may receive, feedback information. The feedback information may include HARQ feedback and/or a feedback codebook. In the context of feedback information (e.g., HARQ feedback), “codebook” refers to a set of one or more (e.g., a matrix of one or more) feedback indications (e.g., ACK or NACK indications) that can be transmitted via a single transmission (e.g., a single uplink transmission, such as via the PUCCH or the PUSCH). In some cases, a wireless node (e.g., a UE) may support HARQ feedback codebook transmissions. A HARQ feedback codebook transmission may include a feedback message that the network entity is to transmit to another network entity to provide feedback regarding, for example, downlink data transmission (for example, transmissions associated with a PDSCH). The network entity may be configured with different types of codebooks, such as a Type-1 HARQ ACK codebook or a Type-2 HARQ ACK codebook. For example, the Type-1 HARQ ACK codebook may be associated with a fixed, or static, size (for example, that is configured by the network entity). The Type-2 HARQ ACK codebook may be associated with a dynamic size (for example, where the size of the Type-2 HARQ ACK codebook is based at least in part on, or otherwise associated with, scheduling received by the network entity). Typically, if the network entity is configured to transmit a Type-1 HARQ ACK codebook, the network entity may collect feedback for one or more communications (e.g., PDSCH communications) that are received by the network entity during a feedback window (for example, k time intervals, such as k slots, k subframes, or k symbols), and may transmit the Type-1 HARQ ACK codebook indicating feedback (for example, ACK/NACK feedback) associated with the PDSCH communications that are received by the network entity during the feedback window. As used herein, a codebook may be a sequence of bits, which may be constructed using ACK/NACK feedback associated with multiple communications (e.g., multiple PDSCH communications) that are received by a network entity during a feedback window. A codebook may include one or more codewords. A codeword may include a message or communication. For example, a codeword may include one or more ACK/NACK feedback indications (e.g., a sequence of one or more HARQ ACK bit values and/or HARQ NACK bit values).

As described elsewhere herein, the first wireless node 505 may configure one or more communication parameters to achieve a target error rate for a given channel, such as the PDSCH. The second wireless node 510 may transmit, and the first wireless node 505 may receive, a codebook indicating feedback (e.g., HARQ ACK/NACK feedback) for the given channel. Because the communication parameter(s) are configured to achieve the target error rate (e.g., target BLER) for the given channel, the feedback information for the given channel will be biased and/or non-uniform. For example, if the target BLER for the PDSCH is 10%, then the probability that feedback is ACK feedback is 90% for a given communication (e.g., a given transport block) transmitted via the PDSCH. In some examples, codebooks may be designed for uniform probability of messages with equal likelihood of the bit 0 and bit 1. In such examples, power is applied uniformly to all codewords in the codebook. For example, each codeword may be transmitted using the same transmit power. This results in inefficient power usage by the network entity transmitting the codebook.

In some examples, a network entity may utilize techniques for power shaping associated with non-uniform message transmissions to improve power savings. For example, more power may be proportionally assigned to less likely symbols (e.g., less likely codewords) and less power to more likely symbols (e.g., more likely codewords) to reduce the average transmit power and improve error performance. For example, the network entity may scale a power of a codeword based on, or otherwise associated with, a probability associated with the codeword. As an example, the network entity (e.g., the second wireless node 510) may perform a power scaling procedure for the codeword c(x^{k}) based on a power scaling parameter. In some examples, the second wireless node 510 may receive the power scaling parameter from the first wireless node 505. In some examples, the power scaling parameter may be associated with a non-uniform probability of respective portions of the message x^{k}. For example, the power scaling procedure may use a scaling parameter of log

$$( \frac{1}{p ( {x}^{k} )} ) ,$$

where p(x) is the non-uniform probability of the use a scaling parameter of log message x^{k}. The message x^{k} may include one or more feedback indications, such as HARQ ACK indications or HARQ NACK indications, among other examples. In other words, if a codeword c has probability π_{c}, then the transmit power allocated to that codeword may be proportional to the probability associated with the codeword (e.g., P_{c}∝−log π_{c}, where P_{c} is a power shaping parameter).

In some examples, techniques for power control for ACK/NACK transmission may scale power according to the probability of a message sequence. For example, if the message sequence x^{k} has probability p(x^{k}), then the power of the corresponding codeword transmission c(x^{k}) may be scaled with log

$$( \frac{1}{p ( {x}^{k} )} ) .$$

Atter normalization with respect to unit expected power over the whole codebook, message sequence x^{k} may be mapped to

$$\sqrt{log ( \frac{1}{p ( {x}^{k} )} ) * \frac{1}{{\sum }_{{x}^{k}} p ( {x}^{k} ) log ( \frac{1}{p ( {x}^{k} )} )}} * c ( {x}^{k} ) ,$$

where the normalization parameter

$$α is \frac{1}{{\sum }_{{x}^{k}} p ( {x}^{k} ) log ( \frac{1}{p ( {x}^{k} )} )} .$$

Techniques for power control for the message comprising independent and identically distributed bit values may scale power according to the probability of a message sequence. If all bits are independent and identically Bernoulli distributed (Bern(p)), the probability may be p(x^{k})=p^{m}(1−p)^{k-m}, where p denotes a probability of bit 1, m denotes a quantity of bit 1 in the message x^{k}, and k denotes the message length. In some cases, the normalization parameter may be simplified to

$$α = {\sum }_{{x}^{k}} p ( {x}^{k} ) log ( \frac{1}{p ( {x}^{k} )} ) = \frac{1}{kH ( p )} ,$$

where H(p)=−p log(p)−(1−p)log(1−p) is the entropy of Bern(p) variable and may be precomputed for a given value of p. The power scaling may be simplified to

$$α * log ( \frac{1}{p ( {x}^{k} )} ) = \frac{1}{k * H ( p )} log ( \frac{1}{p ( {x}^{k} )} ) .$$

In some examples, techniques for power control for the message comprising bits having non-identically distributed bit values may scale power according to the probability of a message sequence. In some cases, the bits may correspond to different types of contents. For example, a subset of message bits may correspond to HARQ-ACK and another subset may correspond to a scheduling request (SR).

In some examples, the probabilities of respective codewords included in the codebook (e.g., included in control channel data) may vary over time. Therefore, using a given encoder (e.g., the same encoder) to encode the control channel data (e.g., using a given codebook and given set of power shaping parameters) may result in degraded communication performance in some examples. For example, the encoder may be configured or designed to improve performance of control channel transmissions for a given data distribution (e.g., a probability distribution for codewords) associated with the control channel transmissions. As the data distribution associated with the control channel may change over time, a performance of control channel transmission transmitted by the wireless node (e.g., that are encoded using the encoder) may be degraded in some cases, such as when the data distribution differs from the data distribution that was used to configure or design the encoder. Additionally, for some data distributions of the control channel and/or for some conditions (e.g., channel conditions and/or wireless node conditions), the power-shaping-based encoding described herein may result in degraded performance as compared to an encoding operation that does not use a power shaping scheme. However, wireless nodes (e.g., a UE and/or a network node) may not be synchronized as to the current data distribution (e.g., probability distribution) associated with the control channel (e.g., a first wireless node may estimate the data distribution, but a second wireless node may not obtain or determine the data distribution). Therefore, modifying the encoding and/or decoding scheme (e.g., as the data distribution changes) may result in errors (e.g., decoding errors) and/or failed communications, among other examples.

As indicated above, FIG. 5 is provided as an example. Other examples may differ from what is described with regard to FIG. 5.

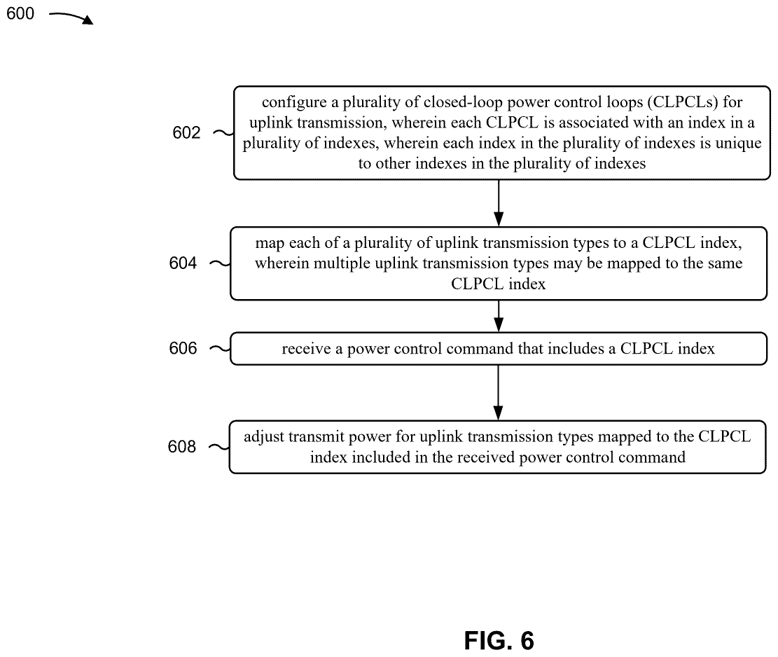

FIG. 6 illustrates a method 600 for wireless communication at a user equipment (UE) according to aspects described herein. The operations of method 600 may be implemented by a UE or its components as described herein. For example, the method 600 may be performed by a wireless communication device, such as the UE 120 described with reference to FIG. 1.

At step 602, the UE configures a plurality of closed-loop power control loops (CLPCLs) for uplink transmission, where each CLPCL is associated with an index in a plurality of indexes. The configuration ensures each index remains unique to other indexes in the plurality of indexes. In certain implementations, this configuration may involve setting up a single closed-loop power control loop having a single index, with the plurality of uplink transmission types mapped to this single index, offering a simplified control structure.

At step 604, the UE maps each of a plurality of uplink transmission types to a respective CLPCL index from the plurality of indexes. This mapping enables multiple uplink transmission types to share the same respective CLPCL index, supporting unified power control across different transmission formats. The uplink transmission types may include Physical Uplink Control Channel (PUCCH), Physical Uplink Shared Channel (PUSCH), Sounding Reference Signal (SRS), or Physical Random Access Channel (PRACH), with at least two of these types typically sharing power control relationships. In some implementations, the mapping accommodates specific operational requirements, such as when PUCCH formats 0, 1, and 4 share an index due to their multi-user operation capabilities, while PUCCH formats 2 and 3 share a different index with PUSCH transmissions.

At step 606, the UE receives a power control command that includes a particular CLPCL index from the plurality of indexes. The power control command typically arrives through downlink control information (DCI) scheduling an uplink or downlink transmission, with the DCI containing an indicator of the particular CLPCL index. For DCI-based commands, the UE identifies a first border of an accumulation region while leaving a second border undefined, enabling streamlined command processing across multiple transmission types. The DCI implementation supports various formats for conveying CLPCL indicators. In one arrangement, the DCI includes CLPCL indicators across a broad range of formats, including DCI formats 0_0, 0_1, 0_2, 1_0, 1_1, 1_2, and 2_2. A more selective implementation incorporates CLPCL indicators specifically in DCI formats 1_0, 1_1, 1_2, and 2_2. For formats 0_0, 0_1, and 0_2, the UE employs an efficient signaling approach by reusing an existing sounding reference signal indicator for Physical Uplink Shared Channel (PUSCH) to indicate the particular CLPCL index, reducing control signaling overhead while maintaining power control functionality.

At step 608, the UE adjusts transmit power for uplink transmission types mapped to the particular CLPCL index included in the received power control command. The UE calculates an adjusted transmit power based on applying the power control command, which may involve applying different step sizes for different transmission types sharing the same index, allowing tailored power control while maintaining the unified framework. When the calculated adjusted transmit power exceeds maximum or minimum transmit power limits for a particular transmission type, the UE sets the transmit power for that transmission type to the respective maximum or minimum transmit power limit.

The UE may perform additional operations to maintain proper power control relationships. When an open-loop power control parameter associated with an uplink transmission type mapped to a particular CLPCL index undergoes reconfiguration, the UE resets a power control state associated with that CLPCL index to an initial value. The UE may also receive explicit signals to reset power control states associated with specific CLPCL indexes, including indications to reset to non-zero power values. To manage these reconfigurations efficiently, the UE can dynamically modify the mapping to change uplink transmission types between different CLPCL indexes, maintaining continuous operation while accommodating necessary power control adjustments.

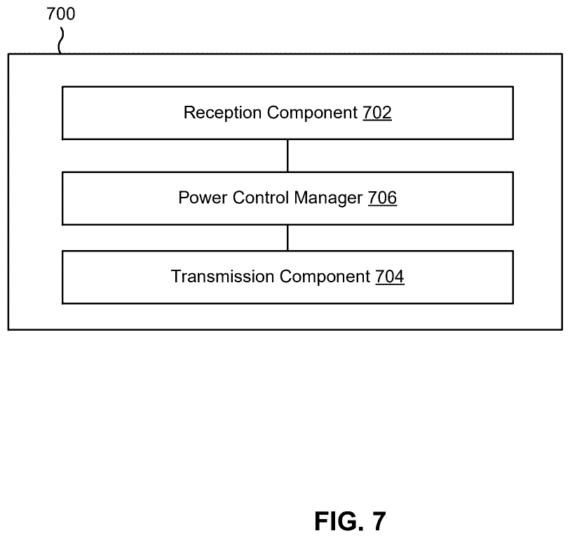

FIG. 7 shows a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a power control manager 706, which may be in communication with one another (for example, via one or more buses and/or one or more other components). In some aspects, the power control manager 706 is the power control manager 140 described in connection with FIG. 1. As shown, the apparatus 700 may communicate with another apparatus 708, such as a network node, using the reception component 702 and the transmission component 704.

In some aspects, the apparatus 700 may be configured to perform one or more operations described herein in connection with method 600. Additionally, or alternatively, one or more components shown in FIG. 7 may include one or more components of the UE described in connection with FIG. 2. Additionally, or alternatively, one or more components shown in FIG. 7 may be implemented within one or more components described in connection with FIG. 2.

The reception component 702 may receive communications, such as power control commands, downlink control information (DCI), and configuration signaling from the apparatus 708. The reception component 702 processes received signals through filtering, amplification, demodulation, analog-to-digital conversion, demultiplexing, deinterleaving, and decoding operations. For DCI-based communications, the reception component 702 processes various DCI formats, including formats 0_0 through 2_2, extracting CLPCL indicators and interpreting reused sounding reference signal indicators for PUSCH to indicate particular CLPCL indexes. The reception component 702 identifies first borders of accumulation regions while leaving second borders undefined and provides processed command information to the power control manager 706.

The transmission component 704 may transmit uplink communications according to power control adjustments determined by the power control manager 706. These transmissions span multiple uplink transmission types, including PUCCH, PUSCH, SRS, and PRACH. The transmission component 704 performs signal processing operations including filtering, amplification, modulation, digital-to-analog conversion, multiplexing, and encoding. The transmission component 704 also maintains separate power control settings for different transmission types even when they share respective CLPCL indexes.

The power control manager 706 configures and maintains the closed-loop power control framework. This component establishes unique CLPCL indices and manages their assignments as respective CLPCL indexes to uplink transmission types. In implementations using a single closed-loop configuration, the power control manager 706 can coordinate all transmission types under one index while preserving their distinct power requirements through different step size interpretations and offsets.

The power control manager 706 also processes power control commands received via the reception component 702 to implement adjustments according to transmission-specific requirements. When multiple transmission types share a respective CLPCL index, the manager calculates adjusted transmit powers using different step sizes—e.g.—larger steps for transmissions with stringent BLER requirements and smaller steps for less demanding transmissions. When calculated adjusted transmit powers would exceed maximum or minimum transmit power limits for particular transmission types, the power control manager 706 sets the transmit powers to the respective maximum or minimum transmit power limits while maintaining proper power tracking.

The power control manager 706 also implements reset mechanisms across the power control framework. When open-loop parameters undergo reconfiguration, the power control manager 706 resets power control states associated with affected CLPCL indexes to initial values. The power control manager 706 also processes explicit reset commands that may specify non-zero power values for power control states, coordinating these resets to maintain continuous operation of other transmission types sharing the same respective CLPCL index. This reset handling preserves power control relationships while accommodating necessary system adjustments.

For dynamic management of transmission types, the power control manager 706 coordinates with the reception component 702 to process mapping modifications received from the network. The manager can dynamically modify mappings to change uplink transmission types between different CLPCL indexes, particularly when anticipating resets of power control states or reconfigurations of specific indexes. This dynamic mapping modification capability ensures uninterrupted power control while maintaining proper relationships among all transmission types.

The components of apparatus 700 may implement specific DCI format handling procedures. The reception component 702 extracts CLPCL indicators from various DCI formats, with particular processing for formats 0_0, 0_1, and 0_2 where sounding reference signal indicators are reused to indicate particular CLPCL indexes. This reuse mechanism reduces control signaling overhead while maintaining precise power control capabilities across all transmission formats.

In some cases, rather than actually transmitting signals and/or data, the transmission component 704 may have an interface to output signals and/or data for transmission. For example, a processor may output signals and/or data, via a bus interface, to an RF front end for transmission. Similarly, rather than actually receiving signals and/or data, the reception component 702 may have an interface to obtain signals and/or data received from another device. For example, a processor may obtain the signals and/or data, via a bus interface, from an RF front end for reception.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of components shown in FIG. 7 may perform one or more functions described as being performed by another set of components shown in FIG. 7.

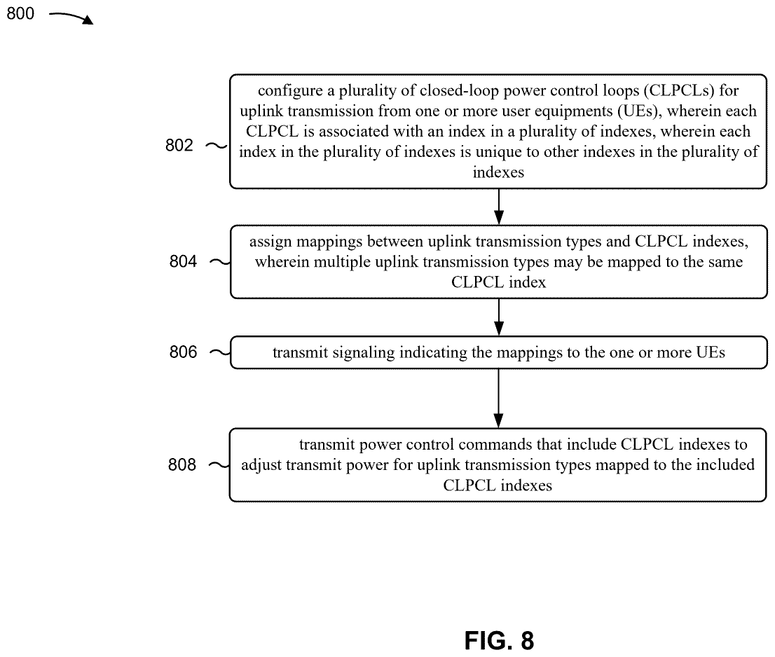

FIG. 8 illustrates a method 800 for wireless communication at a network node according to aspects described herein. The operations of method 800 may be implemented by a network node or its components as described herein. For example, the method 800 may be performed by a wireless communication device, such as the network node 110 described with reference to FIG. 1, which may be implemented as a base station according to certain implementations described herein.

At step 802, the network node configures a plurality of closed-loop power control loops (CLPCLs) for uplink transmission from one or more user equipments (UEs), where each CLPCL is associated with an index in a plurality of indexes. The configuration maintains uniqueness among the indexes, with each index distinct from other indexes in the plurality of indexes. In some implementations, the network node may configure a single closed-loop power control loop having a single index, thereby providing a simplified control structure for the plurality of uplink transmission types.

At step 804, the network node assigns mappings between a plurality of uplink transmission types and respective CLPCL indexes from the plurality of indexes. These assignments allow multiple uplink transmission types to share the same respective CLPCL index, enabling coordinated power control across different transmission formats. The mappings may account for specific operational requirements, such as grouping transmission types with similar interference management needs or quality of service requirements under the same index.

At step 806, the network node transmits signaling indicating the mappings to the one or more UEs. This signaling informs the relationship between uplink transmission types and their assigned respective CLPCL indexes to enable UEs to properly implement the unified power control framework. Further, the network node can transmit power control commands specifically within downlink control information (DCI) that schedules uplink or downlink transmissions, where the DCI includes indicators of particular CLPCL indexes. This DCI-based transmission provides a structured mechanism for conveying both scheduling information and power control commands to the UEs.

At step 808, the network node transmits power control commands that include particular CLPCL indexes from the plurality of indexes to adjust transmit power for uplink transmission types mapped to the included particular CLPCL indexes. These commands enable coordinated power control across multiple transmission types sharing the same respective index. The network node may also transmit signaling to cause a UE to modify its mapping to change an uplink transmission type from being mapped to a first CLPCL index to being mapped to a second CLPCL index prior to transmitting a command to reset a power control state associated with the first CLPCL index. The foregoing dynamic management allows the network node to maintain continuous power control while implementing necessary reconfigurations.

FIG. 9 shows a diagram of an example device 900 for wireless communication in accordance with aspects of the present disclosure. The device 900 may be a network node, such as the network node 110 described in connection with FIG. 1. As shown, the device 900 includes a reception component 902, a transmission component 904, and a power control manager 906, which may be in communication with one another (e.g., via one or more buses and/or one or more other components).

In some aspects, the device 900 may be configured to perform the operations described in connection with the method 800 illustrated in FIG. 8. Additionally, or alternatively, one or more components shown in FIG. 9 may include one or more components of the network node described in connection with FIG. 1. Additionally, or alternatively, one or more components shown in FIG. 9 may be implemented within one or more components described in connection with FIG. 1.

The reception component 902 may receive communications, such as power control commands, downlink control information (DCI), and configuration signaling from other devices (e.g., user equipment (UEs)). The reception component 902 processes the received signals through filtering, amplification, demodulation, analog-to-digital conversion, demultiplexing, deinterleaving, and decoding operations. For DCI-based communications, the reception component 902 processes various DCI formats, including formats 0_0 through 2_2, extracting indicators of particular CLPCL indexes and interpreting reused sounding reference signal indicators for PUSCH.

The transmission component 904 may transmit downlink communications including, e.g., power control commands that include particular CLPCL indexes, according to power control adjustments determined by the power control manager 906. These transmissions may span multiple downlink transmission types, including PDCCH, PDSCH, and others. The transmission component 904 performs signal processing operations including filtering, amplification, modulation, digital-to-analog conversion, multiplexing, and encoding.

The power control manager 906 configures and maintains the closed-loop power control framework for the device 900. This component establishes unique CLPCL indices and manages their assignments as respective CLPCL indexes for uplink transmission types from the UEs. In implementations using a single closed-loop configuration, the power control manager 906 can coordinate all transmission types under one index while preserving their distinct power requirements through different step size interpretations and offsets.

The power control manager 906 also processes power control commands received via the reception component 902 to implement adjustments according to transmission-specific requirements. When multiple transmission types share a respective CLPCL index, the power control manager 906 calculates adjusted transmit powers using different step sizes, e.g., larger steps for transmissions with stringent BLER requirements and smaller steps for less demanding transmissions. When calculated adjusted transmit powers would exceed maximum or minimum power limits, the power control manager 906 sets transmit powers to respective maximum or minimum power limits while maintaining proper power tracking.

The power control manager 906 also implements reset mechanisms across the power control framework. When open-loop parameters undergo reconfiguration, the power control manager 906 resets power control states associated with affected CLPCL indexes to initial values. The power control manager 906 also processes explicit reset commands that may specify non-zero power values for power control states, coordinating these resets to maintain continuous operation of other transmission types sharing the same respective CLPCL index.

For dynamic management of transmission types, the power control manager 906 coordinates with the reception component 902 to process mapping modifications. The power control manager 906 can transmit signaling to cause UEs to modify their mappings to change uplink transmission types between different CLPCL indexes, particularly when anticipating commands to reset power control states associated with specific indexes. This dynamic mapping modification capability ensures uninterrupted power control while maintaining proper relationships among all transmission types.

The components of device 900 may implement specific DCI format handling procedures. The reception component 902 extracts CLPCL indicators from various DCI formats, with particular processing for formats 0_0, 0_1, and 0_2 where sounding reference signal indicators are reused to indicate particular CLPCL indexes.

The following provides an overview of some Aspects of the present disclosure:

Aspect 1: A device for wireless communication, comprising: a processing system that includes one or more processors and one or more memories coupled with the one or more processors, the processing system configured to cause the device to: configure a plurality of closed-loop power control loops (CLPCLs) for uplink transmission, wherein each CLPCL is associated with an index in a plurality of indexes, wherein each index in the plurality of indexes is unique to other indexes in the plurality of indexes; map each of a plurality of uplink transmission types to a respective CLPCL index from the plurality of indexes, wherein multiple uplink transmission types may be mapped to the same respective CLPCL index; receive a power control command that includes a particular CLPCL index from the plurality of indexes; and adjust transmit power for uplink transmission types mapped to the particular CLPCL index included in the received power control command.

Aspect 2: The device of Aspect 1, wherein the processing system is further configured to cause the device to: receive the power control command in a downlink control information (DCI) scheduling an uplink or downlink transmission, wherein the DCI includes an indicator of the particular CLPCL index.

Aspect 3: The device of Aspect 2, wherein the processing system is further configured to cause the device to: identify a first border of an accumulation region for the power control command, wherein a second border of the accumulation region is undefined; and determine, based on the identified accumulation region, which power control commands to apply to the particular CLPCL index.

Aspect 4: The device of Aspect 1, wherein the plurality of uplink transmission types include at least two of: Physical Uplink Control Channel (PUCCH), Physical Uplink Shared Channel (PUSCH), Sounding Reference Signal (SRS), or Physical Random Access Channel (PRACH).

Aspect 5: The device of Aspect 1, wherein the processing system is further configured to cause the device to: adjust transmit power for a first uplink transmission type mapped to the particular CLPCL index by a first step size based on the power control command; and adjust transmit power for a second uplink transmission type mapped to the particular CLPCL index by a second step size based on the power control command, wherein the second step size is different from the first step size.

Aspect 6: The device of Aspect 1, wherein the processing system is further configured to cause the device to: calculate an adjusted transmit power based on applying the power control command; and when the calculated adjusted transmit power exceeds a maximum transmit power or falls below a minimum transmit power for a first uplink transmission type, set the transmit power for the first uplink transmission type to the respective maximum or minimum transmit power limit.

Aspect 7: The device of Aspect 1, wherein the processing system is further configured to cause the device to: reset a power control state associated with a first CLPCL index to an initial value when an open-loop power control parameter associated with an uplink transmission type mapped to the first CLPCL index is reconfigured.

Aspect 8: The device of Aspect 1, wherein the processing system is further configured to cause the device to: receive a signal to reset a power control state associated with one of the plurality of CLPCL indexes.

Aspect 9: The device of Aspect 8, wherein the signal includes an indication to reset the power control state to a non-zero power value.

Aspect 10: The device of Aspect 1, wherein the processing system is further configured to cause the device to: dynamically modify the mapping to change an uplink transmission type from being mapped to a first CLPCL index to being mapped to a second CLPCL index.

Aspect 11: The device of Aspect 2, wherein: the DCI includes a CLPCL indicator for at least one of: DCI format 0_0, DCI format 0_1, DCI format 0_2, DCI format 1_0, DCI format 1_1, DCI format 1_2, or DCI format 2_2.

Aspect 12: The device of Aspect 2, wherein: the DCI includes a CLPCL indicator for at least one of: DCI format 1_0, DCI format 1_1, DCI format 1_2, or DCI format 2_2.

Aspect 13: The device of Aspect 12, wherein: for at least one of DCI format 0_0, DCI format 0_1, or DCI format 0_2, the device is configured to reuse a sounding reference signal indicator for Physical Uplink Shared Channel (PUSCH) to indicate the particular CLPCL index.

Aspect 14: The device of Aspect 1, wherein: the plurality of closed-loop power control loops comprises a single closed-loop power control loop having a single index; and the plurality of uplink transmission types are mapped to the single index.

Aspect 15: A method for wireless communication, comprising: configuring a plurality of closed-loop power control loops (CLPCLs) for uplink transmission, wherein each CLPCL is associated with an index in a plurality of indexes, wherein each index in the plurality of indexes is unique to other indexes in the plurality of indexes; mapping each of a plurality of uplink transmission types to a respective CLPCL index from the plurality of indexes, wherein multiple uplink transmission types may be mapped to the same respective CLPCL index; receiving a power control command that includes a particular CLPCL index from the plurality of indexes; and adjusting transmit power for uplink transmission types mapped to the particular CLPCL index included in the received power control command.

Aspect 16: The method of Aspect 15, further comprising: receiving the power control command in a downlink control information (DCI) scheduling an uplink or downlink transmission, wherein the DCI includes an indicator of the particular CLPCL index; and identifying a first border of an accumulation region for the power control command, wherein a second border of the accumulation region is undefined; and determining, based on the identified accumulation region, which power control commands to apply to the particular CLPCL index.

Aspect 17: The method of Aspect 15, wherein the plurality of uplink transmission types include at least two of: Physical Uplink Control Channel (PUCCH), Physical Uplink Shared Channel (PUSCH), Sounding Reference Signal (SRS), or Physical Random Access Channel (PRACH).

Aspect 18: The method of Aspect 15, further comprising: adjusting transmit power for a first uplink transmission type mapped to the particular CLPCL index by a first step size based on the power control command; and adjusting transmit power for a second uplink transmission type mapped to the particular CLPCL index by a second step size based on the power control command, wherein the second step size is different from the first step size.

Aspect 19: The method of Aspect 15, further comprising: calculating an adjusted transmit power based on applying the power control command; and when the calculated adjusted transmit power exceeds a maximum transmit power or falls below a minimum transmit power for a first uplink transmission type, setting the transmit power for the first uplink transmission type to the respective maximum or minimum transmit power limit.

Aspect 20: The method of Aspect 15, further comprising: resetting a power control state associated with a first CLPCL index to an initial value when an open-loop power control parameter associated with an uplink transmission type mapped to the first CLPCL index is reconfigured; receiving a signal to reset a power control state associated with one of the plurality of CLPCL indexes, wherein the signal includes an indication to reset the power control state to a non-zero power value; and dynamically modifying the mapping to change an uplink transmission type from being mapped to a first CLPCL index to being mapped to a second CLPCL index.

Aspect 21: The method of Aspect 15, wherein: the DCI includes a CLPCL indicator for at least one of: DCI format 0_0, DCI format 0_1, DCI format 0_2, DCI format 1_0, DCI format 1_1, DCI format 1_2, or DCI format 2_2; and for at least one of DCI format 0_0, DCI format 0_1, or DCI format 0_2, reusing a sounding reference signal indicator for Physical Uplink Shared Channel (PUSCH) to indicate the particular CLPCL index.

Aspect 22: The method of Aspect 15, wherein: the plurality of closed-loop power control loops comprises a single closed-loop power control loop having a single index; and the plurality of uplink transmission types are mapped to the single index.

Aspect 23: A device for wireless communication, comprising: a processing system that includes one or more processors and one or more memories coupled with the one or more processors, the processing system configured to cause the device to: configure a plurality of closed-loop power control loops (CLPCLs) for uplink transmission from one or more user equipments (UEs), wherein each CLPCL is associated with an index in a plurality of indexes, wherein each index in the plurality of indexes is unique to other indexes in the plurality of indexes; assign mappings between a plurality of uplink transmission types and respective CLPCL indexes from the plurality of indexes, wherein multiple uplink transmission types may be mapped to the same respective CLPCL index; transmit signaling indicating the mappings to the one or more UEs; and transmit power control commands that include particular CLPCL indexes from the plurality of indexes to adjust transmit power for uplink transmission types mapped to the included particular CLPCL indexes.

Aspect 24: The device of Aspect 23, wherein the processing system is further configured to cause the device to: transmit the power control commands in downlink control information (DCI) scheduling an uplink or downlink transmission, wherein the DCI includes an indicator of a particular CLPCL index.

Aspect 25: The device of Aspect 23, wherein the processing system is further configured to cause the device to: configure a single closed-loop power control loop having a single index; and assign mappings to map the plurality of uplink transmission types to the single index.

Aspect 26: The device of Aspect 23, wherein the processing system is further configured to cause the device to: transmit signaling to cause a UE to modify its mapping to change an uplink transmission type from being mapped to a first CLPCL index to being mapped to a second CLPCL index prior to transmitting a command to reset a power control state associated with the first CLPCL index.

Aspect 27: An apparatus, including: at least one memory including executable instructions; and at least one processor configured to execute the executable instructions and cause the apparatus to perform a method in accordance with any combination of Aspects 15-22.

Aspect 28: An apparatus, including means for performing a method in accordance with any combination of Aspects 15-22.

Aspect 29: A non-transitory computer-readable medium including executable instructions that, when executed by at least one processor of an apparatus, cause the apparatus to perform a method in accordance with any combination of Aspects 15-22.

Aspect 30: A computer program product embodied on a computer-readable storage medium including code for performing a method in accordance with any combination of Aspects 15-22.

Aspect 31: A User Equipment (UE), including: at least one transceiver; at least one memory including instructions; and one or more processors, individually or collectively, configured to perform the operations of Aspect 1.

Aspect 32: A base station, including: at least one transceiver; at least one memory including instructions; and one or more processors, individually or collectively, configured to perform the operations of Aspect 23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

Further, while the present disclosure may describe certain types of communications between different types of wireless nodes (e.g., between a network node and a UE), the same or similar types of communications may occur between same types of wireless nodes (e.g., between network nodes or between UEs, in a peer-to-peer scenario). Further, communications may occur in reverse order than described.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

1. A device for wireless communication, comprising: a processing system that includes one or more processors and one or more memories coupled with the one or more processors, the processing system configured to cause the device to:
configure a plurality of closed-loop power control loops (CLPCLs) for uplink transmission, wherein each CLPCL is associated with an index in a plurality of indexes, wherein each index in the plurality of indexes is unique to other indexes in the plurality of indexes;
map each of a plurality of uplink transmission types to a respective CLPCL index from the plurality of indexes, wherein multiple uplink transmission types may be mapped to the same respective CLPCL index;
receive a power control command that includes a particular CLPCL index from the plurality of indexes; and
adjust transmit power for uplink transmission types mapped to the particular CLPCL index included in the received power control command.

2. The device of claim 1, wherein the processing system is further configured to cause the device to:
receive the power control command in a downlink control information (DCI) scheduling an uplink or downlink transmission, wherein the DCI includes an indicator of the particular CLPCL index.

3. The device of claim 2, wherein the processing system is further configured to cause the device to:
identify a first border of an accumulation region for the power control command, wherein a second border of the accumulation region is undefined; and
determine, based on the identified accumulation region, which power control commands to apply to the CLPCL index.

4. The device of claim 1, wherein the plurality of uplink transmission types include at least two of: Physical Uplink Control Channel (PUCCH), Physical Uplink Shared Channel (PUSCH), Sounding Reference Signal (SRS), or Physical Random Access Channel (PRACH).

5. The device of claim 1, wherein the processing system is further configured to cause the device to:
adjust transmit power for a first uplink transmission type mapped to the particular CLPCL index by a first step size based on the power control command; and
adjust transmit power for a second uplink transmission type mapped to the particular CLPCL index by a second step size based on the power control command, wherein the second step size is different from the first step size.

6. The device of claim 1, wherein the processing system is further configured to cause the device to:
calculate an adjusted transmit power based on applying the power control command; and
when the calculated adjusted transmit power exceeds a maximum transmit power or falls below a minimum transmit power for a first uplink transmission type, set the transmit power for the first uplink transmission type to the respective maximum or minimum transmit power limit.

7. The device of claim 1, wherein the processing system is further configured to cause the device to:
reset a power control state associated with a first CLPCL index to an initial value when an open-loop power control parameter associated with an uplink transmission type mapped to the first CLPCL index is reconfigured.

8. The device of claim 1, wherein the processing system is further configured to cause the device to:
receive a signal to reset a power control state associated with one of the plurality of CLPCL indexes.

9. The device of claim 8, wherein the signal includes an indication to reset the power control state to a non-zero power value.

10. The device of claim 1, wherein the processing system is further configured to cause the device to:
dynamically modify the mapping to change an uplink transmission type from being mapped to a first CLPCL index to being mapped to a second CLPCL index.

11. The device of claim 2, wherein:
the DCI includes a CLPCL indicator for at least one of: DCI format 0_0, DCI format 0_1, DCI format 0_2, DCI format 1_0, DCI format 1_1, DCI format 1_2, or DCI format 2_2.

12. The device of claim 2, wherein:
the DCI includes a CLPCL indicator for at least one of: DCI format 1_0, DCI format 1_1, DCI format 1_2, or DCI format 2_2.

13. The device of claim 12, wherein:
for at least one of DCI format 0_0, DCI format 0_1, or DCI format 0_2, the device is configured to reuse a sounding reference signal indicator for Physical Uplink Shared Channel (PUSCH) to indicate the particular CLPCL index.

14. The device of claim 1, wherein:
the plurality of closed-loop power control loops comprises a single closed-loop power control loop having a single index; and
the plurality of uplink transmission types are mapped to the single index.

15. A method for wireless communication, comprising:
configuring a plurality of closed-loop power control loops (CLPCLs) for uplink transmission, wherein each CLPCL is associated with an index in a plurality of indexes, wherein each index in the plurality of indexes is unique to other indexes in the plurality of indexes;
mapping each of a plurality of uplink transmission types to a respective CLPCL index from the plurality of indexes, wherein multiple uplink transmission types may be mapped to the same respective CLPCL index;
receiving a power control command that includes a particular CLPCL index from the plurality of indexes; and
adjusting transmit power for uplink transmission types mapped to the particular CLPCL index included in the received power control command.

16. The method of claim 15, further comprising:
receiving the power control command in a downlink control information (DCI) scheduling an uplink or downlink transmission, wherein the DCI includes an indicator of the particular CLPCL index; and
identifying a reference time point defining a start of an accumulation region for the power control command, wherein an end of the accumulation region remains undefined; and
determining, based on the identified reference time point, which power control commands to apply to the particular CLPCL index.

17. The method of claim 15, wherein the plurality of uplink transmission types include at least two of: Physical Uplink Control Channel (PUCCH), Physical Uplink Shared Channel (PUSCH), Sounding Reference Signal (SRS), or Physical Random Access Channel (PRACH).

18. The method of claim 15, further comprising:
adjusting transmit power for a first uplink transmission type mapped to the particular CLPCL index by a first step size based on the power control command; and
adjusting transmit power for a second uplink transmission type mapped to the particular CLPCL index by a second step size based on the power control command, wherein the second step size is different from the first step size.

19. The method of claim 15, further comprising:
calculating an adjusted transmit power based on applying the power control command; and
when the calculated adjusted transmit power exceeds a maximum transmit power or falls below a minimum transmit power for a first uplink transmission type, setting the transmit power for the first uplink transmission type to the respective maximum or minimum transmit power limit.

20. The method of claim 15, further comprising:
resetting a power control state associated with a first CLPCL index to an initial value when an open-loop power control parameter associated with an uplink transmission type mapped to the first CLPCL index is reconfigured;
receiving a signal to reset a power control state associated with one of the plurality of CLPCL indexes, wherein the signal includes an indication to reset the power control state to a non-zero power value; and
dynamically modifying the mapping to change an uplink transmission type from being mapped to a first CLPCL index to being mapped to a second CLPCL index.

21. The method of claim 15, wherein:
the DCI includes a CLPCL indicator for at least one of: DCI format 0_0, DCI format 0_1, DCI format 0_2, DCI format 1_0, DCI format 1_1, DCI format 1_2, or DCI format 2_2; and
for at least one of DCI format 0_0, DCI format 0_1, or DCI format 0_2, reusing a sounding reference signal indicator for Physical Uplink Shared Channel (PUSCH) to indicate the particular CLPCL index.

22. The method of claim 15, wherein:
the plurality of closed-loop power control loops comprises a single closed-loop power control loop having a single index; and
the plurality of uplink transmission types are mapped to the single index.

23. A device for wireless communication, comprising: a processing system that includes one or more processors and one or more memories coupled with the one or more processors, the processing system configured to cause the device to:
configure a plurality of closed-loop power control loops (CLPCLs) for uplink transmission from one or more user equipments (UEs), wherein each CLPCL is associated with an index in a plurality of indexes, wherein each index in the plurality of indexes is unique to other indexes in the plurality of indexes;
assign mappings between a plurality of uplink transmission types and respective CLPCL indexes from the plurality of indexes, wherein multiple uplink transmission types may be mapped to the same respective CLPCL index;
transmit signaling indicating the mappings to the one or more UEs; and
transmit power control commands that include particular CLPCL indexes from the plurality of indexes to adjust transmit power for uplink transmission types mapped to the included particular CLPCL indexes.

24. The device of claim 23, wherein the processing system is further configured to cause the device to:
transmit the power control commands in downlink control information (DCI) scheduling an uplink or downlink transmission, wherein the DCI includes an indicator of a particular CLPCL index.

25. The device of claim 23, wherein the processing system is further configured to cause the device to:
configure a single closed-loop power control loop having a single index; and
assign mappings to map the plurality of uplink transmission types to the single index.

26. The device of claim 23, wherein the processing system is further configured to cause the device to:
transmit signaling to cause a UE to modify its mapping to change an uplink transmission type from being mapped to a first CLPCL index to being mapped to a second CLPCL index prior to transmitting a command to reset a power control state associated with the first CLPCL index.
